(19) United States
(12) Patent Application Publication
(10) Pub. No.: US 2020/0230600 A1
(43) Pub. Date: Jul. 23, 2020

(54) APPARATUS AND METHODS FOR HANDLING LIQUID

(71) Applicant: BIOSURFIT, S.A., Azambuja (PT)

(72) Inventors: David Pena De Sousa SANTOS, LISBOA (PT); Miguel João Marques BARREIROS, LISBOA (PT); Fábio Miguel Rolo PEREIRA, LISBOA (PT)

(73) Assignee: BIOSURFIT, S.A., Azambuja (PT)

(21) Appl. No.: 16/634,327

(22) PCT Filed: Jul. 27, 2018
(86) PCT No.: PCT/EP2018/070491

§ 371 Date: Jan. 27, 2020

(30) Foreign Application Priority Data
Jul. 27, 2017 (GB) 1712074.2
Jul. 27, 2017 (PT) 110222 T

(51) Int. Cl. B01L 3/00

(52) U.S. Cl. CPC B01L 3/502746; B01L 3/50273; B01L 2200/0605; B01L 2200/0621; B01L 2200/0684; B01L 2400/086; B01L 2300/161; B01L 2400/0406; B01L 2400/0409; B01L 2400/0688; B01L 2300/087

(57) ABSTRACT

A microfluidic device includes an upstream liquid handling structure to hold a first volume of liquid, a downstream liquid handling structure to hold a second volume of liquid smaller than the first volume and including a vent port. The upstream liquid handling structure is connected to a detection chamber, for supplying liquid to the detection chamber and the detection chamber is connected to the downstream liquid handling structure, for supplying liquid to the downstream liquid handling structure. The downstream liquid handling structure facilitates flow of an aqueous liquid through the detection chamber and into the downstream liquid handling structure by capillary action. The downstream liquid handling structure includes a flow-halting feature to halt the flow of the liquid by capillary action when the downstream liquid handling structure has filled with the second volume of liquid.

### RELATED APPLICATIONS

The present application is a National Phase entry of PCT Application No. PCT/EP2018/070491, filed Jul. 27, 2018, which claims priority from Great Britain Application No. 1712074.2 filed Jul. 27, 2017 and Portuguese Application No. 110222T filed Jul. 27, 2017, all of these disclosures being hereby incorporated by reference in their entirety.

### FIELD OF THE INVENTION

The present invention relates to handling of liquids, for example in a microfluidic device such as a ‘lab on a disk’ device. Such devices are used to determine characteristics of a liquid. In particular, they may be used to determine characteristics of a blood sample, for example a blood cell or platelet count.

### SUMMARY OF THE INVENTION

A number of structures and methods are provided which facilitate the handling of liquid in order to determine characteristics of that liquid.

Aspects of the disclosure are set out in the independent claims. Further, optional features of embodiments are set out in the dependent claims.

In one aspect there is provided a microfluidic device for metering liquid. The device comprises an upstream liquid handling structure configured to hold a first volume of liquid, a downstream liquid handling structure configured to hold a second volume of liquid smaller than the first volume and comprising a vent port and a detection chamber. The upstream liquid handling structure is connected to the detection chamber for supplying liquid to the detection chamber and the downstream liquid handling structure is connected to the detection chamber for receiving liquid from the detection chamber. At least part of the downstream liquid handling structure is configured to facilitate flow of an aqueous liquid through the detection chamber and into the downstream liquid handling structure by capillary action. The downstream liquid handling structure comprises a flow-halting feature which is configured to halt the flow of the liquid when the downstream liquid handling structure has filled with the second volume of liquid.

It will be understood that capillary forces driving flow into the downstream liquid handling structure may be generated by the shape, dimensions, surface properties and/or configurations of the liquid confining elements such as conduits and chambers in the device, for example the downstream liquid handling structure. Capillary forces may be caused by other means, for example by a liquid absorbing medium, such as a porous medium, for example a textile, filter paper or foam member.

In some embodiments, the upstream liquid handling structure is connected to the detection chamber by a first conduit. In some embodiments the detection chamber is connected to the downstream liquid handling structure by a second conduit. One or both of the first and second conduits may be configured to facilitate flow of liquid under the action of capillary forces through the detection chamber and into the downstream liquid handling structure.

In other embodiments, the upstream liquid handling structure is directly connected to the detection chamber, with no intervening structures and/or the detection chamber is directly connected to the downstream liquid handling structure, with no intervening structures.

In some embodiments, the flow-halting feature comprises a step change in the cross-sectional area of the downstream liquid handling structure. This may be otherwise referred to as a capillary valve. In some embodiments, the device has a planar shape and the step-change in the cross-sectional area of the downstream liquid handling structure is provided by a step-change in a depth of the chamber (in a direction perpendicular to the plane of the device) and/or a step-change in a width of the chamber (in a direction parallel to the plane of the device).

In other embodiments, the flow-halting feature comprises a wall of the downstream liquid handling structure, such that the downstream liquid handling structure is configured to be filled entirely with the second volume of liquid. In other words, capillary flow of liquid into the downstream liquid handling structure may cease once the downstream liquid handling structure is full of liquid.

In some embodiments, the flow-halting feature may comprise hydrophobic material or surface modification. This could be a hydrophobic region perpendicular to the direction of liquid flow in the downstream liquid handling structure. The hydrophobic region could be used in combination with the above-described capillary valve.

The above-described structures are based on the realisation that the volume of liquid which flows through a given structure, such as a detection chamber or conduit, may be limited (and hence determined) by limiting the volume of liquid which is able to flow into a structure which is downstream of the detection chamber. In particular, the downstream liquid handling structure is configured to hold a volume of liquid which is smaller than that which is available to be supplied by the upstream liquid handling structure. The downstream liquid handling structure is too small to hold all the liquid which is originally held in the upstream liquid handling structure. Flow thus ceases before the liquid supply from the upstream liquid handling structure runs out. Knowledge of the volume of liquid which can be held in the downstream chamber (either obtained based on dimensions of the downstream liquid handling structure or by other means, for example during testing) facilitates the determination of how much liquid has flowed into the downstream liquid handling structure. This volume is equal to the volume that has flowed through the detection chamber.

This approach is particularly useful when used in conjunction with observing liquid as it flows under the action of capillary forces, e.g. through a detection chamber. The volume of liquid which has passed through the detection chamber (i.e. the volume of liquid which has been imaged or otherwise observed) can be determined because it is equal to the volume of liquid which can be held in the downstream liquid handling structure (i.e. the second volume—see above). This is useful in determining a characteristic of the liquid, for example an object count, for example a count of cells or other objects, in a blood sample.

The advantages of using this approach, as opposed to metering a volume of liquid upstream of the detection chamber are as follows:
A downstream structure is required if liquid is to flow through a detection chamber anyway (e.g. in the form of a waste-chamber). By using for the additional purpose of metering a chamber which is present anyway, the need for additional structures and/or processing steps in order to meter a volume of liquid upstream of the detection chamber is avoided.
It is generally easier to ensure a structure is filled (either completely filled or filled up to a flow-halting structure) then to ensure a structure (e.g. an upstream metering chamber) is emptied entirely, especially when liquid flows through the detection chamber and into the downstream structure under the action of capillary forces, as opposed to centrifugal forces, for example. It is thus possible to facilitate a more accurate determination of the volume of liquid which has flowed through the detection chamber.

In some embodiments, at least part of the downstream liquid handling structure is lined with a hydrophilic material. This is advantageous in that it facilitates the use of a downstream liquid handling structure which has a wide variety of shapes while maintaining capillary flow. For example, the cross-sectional area of the downstream liquid handling structure may increase along the direction of liquid flow, in which case a hydrophilic film may assist in acting to draw liquid further into the downstream liquid handling structure, even if capillary forces cease on account of the increase in cross-sectional area. Configuring the downstream liquid handling structure such that the cross-sectional area of the structure increases along the direction of flow of liquid into the structure in this way may be advantageous in the case that the structure is implemented on a lab-on-a-disk device, where radial space may be limited (on account of other structures on the device). This is because the structure can be made to have a greater circumferential extent and/or depth, such that a greater volume of liquid can be held in the structure for a given radial extent of the structure

In some embodiments, the downstream liquid handling structure comprises a first end and a second end opposed to the first end, wherein the downstream liquid handling structure is connected to the detection chamber (e.g. via the second conduit—see above) at the first end. A cross-sectional area of the downstream chamber at the first end is smaller than a cross-sectional area of the downstream structure at the second end. This may have the advantage of saving on radial space whilst still facilitating the flow of a sufficiently large volume of liquid into the downstream liquid handling structure as described above. The cross-sectional area may increase steadily between the first and second ends. Any step-changes in cross-sectional area may be avoided in order to facilitate flow of the liquid into the chamber under the action of capillary forces.

As mentioned above, in some embodiments, the device has a planar shape. The device may be a disc, for example. The difference in the cross-sectional area of the downstream liquid handling structure may be provided by a change in a depth of the chamber (perpendicular to the plane of the device) and/or a change in a width of the chamber (parallel to the plane of the device).

In some embodiments, the downstream liquid handling structure is a chamber. In other embodiments, the downstream liquid handling structure may be a conduit, a plurality of conduits or channels or any combination of a chamber, a channel or a plurality of channels.

In some embodiments, the downstream liquid handling structure comprises one or more structures to aid in filling the downstream liquid handling structure by capillarity. For example, the structures may comprise one or more pillars, extending from one surface of the downstream liquid handling structure to an opposing surface of the downstream liquid handling structure. By providing pillars, a series of narrow spaces within the downstream liquid handling structure (i.e. between the pillars) are provided. Liquid is drawn into these narrow spaces under the action of capillary forces. Providing pillars thus aids in filling of the downstream liquid handling structure. The same effect may be achieved by configuring the downstream liquid handling structure as a series of channels. A series of narrow spaces is provided by the series of channels themselves. In either case, providing a series of narrow spaces as described also reduces the risk of the formation of gas bubbles as liquid flows into the downstream liquid handling structure. Capillary forces may be caused by other means, for example by a liquid absorbing medium, such as a porous medium, for example a textile, filter paper or foam member disposed in the downstream liquid handling structure.

In a further aspect there is provided a method of handling liquid in a device comprising a detection chamber connected to a downstream liquid handling structure. The method comprises causing liquid to flow through the detection chamber and into the downstream liquid handling structure under the action of capillary forces and determining a volume of liquid that has flowed through the detection chamber based on the configuration of the downstream liquid handling structure.

In some embodiments, the method comprises completely filling the downstream liquid handling structure with liquid. In other embodiments, the method comprises causing liquid to flow into the downstream liquid handling structure until the liquid comes into contact with a flow-halting feature in the downstream liquid handling structure.

In some embodiments the method comprises observing the liquid as it flows through the detection chamber. This may comprise capturing one or more images of the liquid and/or determining one or more characteristics of the liquid using suitable detection systems, e.g. by performing photometry or flow cytometry (based on optical or impedance measurements) on the liquid, or using surface sensors (e.g. surface plasmon resonance), etc. In the case that a plurality of images of the liquid sample are captured during flow, the image capturing device used may be configured such that the focal depth of the image capture device varies over time, for example in line with the method described in application GB1605897.6 and subsequently published in related PCT Publication WO2017/174652.

In order to facilitate observation of the liquid as it flows through the detection chamber, one or more surfaces of the detection chamber may be configured to enable light to pass through the one or more surfaces. The one or more surfaces may be transparent or translucent.

In a further aspect there is provided a microfluidic liquid handling device configured for rotation about an axis of rotation to drive liquid flow within the device. The device comprises a chamber with a liquid inlet and a liquid outlet. The liquid outlet is connected to an outlet conduit. The device is configured to facilitate flow of an aqueous liquid out of the chamber into the conduit by capillary action. The outlet conduit extends from the outlet radially inwards. In other words, the outlet conduit extends from the outlet first in a radially-inwards direction such that liquid flowing out of the chamber, through the outlet, first flows radially inwards.

This structure is advantageous when liquid in the chamber has a density gradient, for example a gradient in the distribution of objects in the liquid in the chamber. Taking the example of a blood sample, a blood sample in the chamber may have been separated into its components (platelets, red and white blood cells material, plasma, etc.), under the action of the centrifugal force. After such centrifugal separation, there is a density gradient of platelets within the plasma. By positioning the outlet as described above, such that liquid flows out of the chamber in a radially-inwards direction, the distribution of platelets across a width of the outlet conduit (perpendicular to the direction of flow of liquid along the conduit) is substantially uniform. The density of platelets in the plasma flowing past a certain point in the outlet conduit increases over time as liquid flows along the outlet conduit. This is because over time, the liquid that is extracted from the chamber is more and more dense (on account of the density gradient within the chamber). However, over the course of liquid flow, the variation in density averages out.

If instead the plasma was extracted from the side of the chamber, such that liquid flowing out of the chamber via the outlet flowed in a circumferential direction first, rather than a radially-inwards direction first, there would be a density gradient of platelets across the conduit (in a direction perpendicular to the direction of liquid flow along the conduit). There would be more platelets at the radially-outer edge of the conduit than at a radially-inner edge. This can be problematic when capturing images of the liquid as it flows along the conduit. If the field of view of the image capture device being used is positioned within the walls of the conduit (i.e. less than the whole width of the conduit falls within the field of view), this non-uniformity in objects would skew a count of the objects. For example, the platelets clustered along a radially-outer edge of the conduit may fall outside the field of view and hence would not be captured. This means that the images of the sample that are captured as the sample flows are not truly representative of the number of objects in the liquid. Thus, when the number of objects is scaled up to a count of objects per volume of blood, the determined count is then not the true count.

Conversely, by extracting liquid from the chamber in the way detailed above, such that liquid flows radially inwards, the density gradient in the objects is averaged out over time, as the sample flows along the conduit. Any change in density gradient over time is thus accounted for in obtaining an object count. It will be appreciated that, while explained in relation to the examples of platelets in plasma, the principles equally apply to any objects disposed in any liquid with a radial gradient.

A further advantage is that the distribution of platelets is more reproducible between tests using the device. Specifically, when a sample is extracted from the side of the chamber using capillary action, the region of the chamber from which liquid is ingested in the outlet is variable. On the other hand, by extracting from the chamber using the outlet conduit in a radially inwards direction, the extracted is from a well-defined, radially innermost region of the chamber (determined by extraction time or otherwise, for example as described below).

It will be understood that capillary forces driving flow may be generated by the shape, dimensions, surface properties and/or configurations of the liquid confining elements such as conduits and chambers in the device, for example a conduit, a detection chamber and/or a waste chamber downstream of the detection chamber (as long as the waste chamber or outlet conduit is wetted in the first instance to cause capillary flow). Capillary forces may be caused by other means, for example by a liquid absorbing medium, such as a porous medium, for example a textile, filter paper or foam member.

In some embodiments, the outlet conduit is connected to a detection chamber. The detection chamber may be configured to facilitate observation of the liquid when it is in the detection chamber, for example when it is flowing though the detection chamber. In order to facilitate observation of the liquid as it flows through the detection chamber, one or more surfaces of the detection chamber may be configured to enable light to pass through the one or more surfaces. The one or more surfaces may be transparent or translucent.

Alternatively or additionally, the outlet conduit may be configured to facilitate observation of the liquid when it is in the outlet conduit, for example when it is flowing though the outlet conduit. One or more surfaces of the outlet conduit may be configured to enable light to pass through the one or more surfaces. The one or more surfaces may be transparent or translucent.

In some embodiments a width of the chamber in a circumferential direction decreases in a radially inwards direction to connect to the liquid outlet. This provides a smooth transition between the chamber and the outlet, thus reducing the risk of the formation of gas bubbles and providing a more homogeneous flow.

In some embodiments, a width of the chamber in a circumferential direction increases along a radially-inwards direction and then decreases along the radially-inwards direction to connect to the liquid outlet. This provides a smooth transition between the chamber and the outlet, thus reducing the risk of the formation of gas bubbles.

In some embodiments, the outlet conduit comprises a capillary siphon. In other words, the outlet conduit may extend radially inwards to a crest and then radially outwards from the crest. The crest may be disposed radially inwards of the liquid inlet of the chamber.

In some embodiments, a portion of the chamber, or a portion of a liquid handling structure arranged in a communicating vessel arrangement with the chamber, extends radially inward of the outlet. Such an arrangement facilitates wetting of the outlet as liquid is driven into and separated within the chamber under the action of the centrifugal force.

In some embodiments, the chamber is angled with respect to a radial direction through the chamber. For example, the chamber may form an acute angle with a radial direction through the chamber. Angling the chamber in this way compensates for the Coriolis force so that particles in the liquid travel down centre of chamber, rather than hitting a wall of the chamber, thus hindering sedimentation.

In a further aspect there is provided a method of handling liquid in a microfluidic device. The device comprises a chamber with a liquid inlet and a liquid outlet. The liquid outlet is connected to an outlet conduit which is configured to facilitate flow of an aqueous liquid out of the chamber into the conduit by capillary action. The outlet conduit extends from the outlet radially inwards. The method comprises transferring a liquid sample having a plurality of components of differing densities into the chamber, rotating the device about an axis of rotation to separate the plurality of components in the radial direction and decreasing the rotational frequency of the device or stopping rotation of the device to cause liquid to flow out of the chamber via the liquid outlet under the action of capillary forces.

In some embodiments, the method comprises observing the liquid sample as it flows through the outlet conduit. In some embodiments, the outlet conduit is connected to a detection chamber and the method comprises observing the liquid sample as it flows through the detection chamber. Observing the liquid may comprise capturing one or more images of the liquid and/or determining one or more characteristics of the liquid using suitable detection systems, e.g. by performing photometry or flow cytometry (based on optical or impedance measurements) on the liquid, or using surface sensors (e.g. surface plasmon resonance), etc.

In some embodiments, the liquid is a blood sample or a component of a blood sample, for example plasma.

In one aspect there is provided a method of observing liquid in a microfluidic device comprising a detection chamber which is configured to allow light to pass into and out of the detection chamber. The method comprises rotating the device while filling the detection chamber with liquid, and subsequently decreasing the rotational frequency of the device or stopping rotation of the device to cause the liquid to flow through the detection chamber under the action of capillary forces and observing the liquid as it flows through the detection chamber by capillary action. While filling the detection chamber, filling the device with liquid may be achieved by rotating the device to drive liquid flow into the detection chamber using the centrifugal force.

It will be understood that capillary forces driving flow may be generated by the shape, dimensions, surface properties and/or configurations of the liquid confining elements such as conduits and chambers in the device, for example the detection chamber and/or a waste chamber downstream of the detection chamber (as long as the waste chamber or outlet conduit is wetted in the first instance to cause capillary flow). Capillary forces may be caused by other means, for example by a liquid absorbing medium, such as a porous medium, for example a textile, filter paper or foam member.

In some embodiments, observing the liquid comprises capturing one or more images of the liquid and/or determining one or more characteristics of the liquid using suitable detection systems, e.g. by performing photometry or flow cytometry (based on optical or impedance measurements) on the liquid, or using surface sensors (e.g. surface plasmon resonance), etc.

By filling the detection chamber under the action of centrifugal force, any gas that was present in the detection chamber prior to filling the detection chamber with liquid and also gas present in the form of bubbles in the liquid, is forced radially inwards of the liquid. This occurs due to the difference in density between the liquid and the gas; the less-dense gas moves radially inwards under the action of centrifugal force (as a result of the liquid being forced radially outwards) and the denser liquid is forced radially outwards. This has the effect that once the detection chamber has been filled with liquid under the action of centrifugal force, the liquid is substantially free of gas bubbles and no gas is trapped in the detection chamber. When the device is then slowed or stopped to facilitate flow of liquid through the detection chamber under the action of capillary forces, the flow is not hindered by trapped gas or gas bubbles. Further, avoiding gas bubbles in the liquid means that an accurate determination of the volume of liquid which has flowed through the detection chamber can be obtained, for example in line with the methods described above with respect to filling a downstream liquid handling structure up to a flow-halting feature. Filling detection chambers under the action of centrifugal force are discussed for example in WO2011/122972 and WO2012/131556 which are both incorporated herein by reference.

The detection chamber comprises an inlet and an outlet. In some embodiments, the outlet is disposed at a radially-innermost aspect of the detection chamber. This means that, as the detection chamber is filled with liquid under the action of centrifugal force and any gas in the chamber (and optionally gas in the liquid) is forced radially inward of the liquid, the gas is able to escape out of the detection chamber via the outlet (which is disposed at a radially innermost aspect of the detection chamber). In this way, the detection chamber can be filled entirely with liquid and gas bubbles in the detection chamber can be avoided.

In other embodiments, the outlet may be disposed elsewhere in the detection chamber (i.e. not at a radially innermost aspect of the detection chamber). For example, the outlet may be disposed radially inwards of the inlet. In embodiments where the outlet is not disposed at a radially-innermost aspect of the detection chamber, the detection chamber may also comprise a vent port disposed radially inwards of the outlet, optionally at a radially-innermost aspect of the detection chamber. As the detection chamber is filled with liquid, gas is able to escape out of the detection chamber via the vent port, thus avoiding trapping gas bubbles in the detection chamber. The vent port may be connected to an internal air circuit or may be in communication with the atmosphere external to the device.

For example, a detection chamber arrangement as described in application GB 1617081.3 and subsequently published in related PCT Publication WO2018/065208 may be used.

In some embodiments, the microfluidic device further comprises a liquid holding chamber connected to the detection chamber via a conduit. The method comprises, prior to rotating the device to fill the detection chamber with liquid, rotating the device to transfer liquid into the liquid holding chamber and changing the rotational frequency of the device to transfer liquid out of the liquid holding chamber and into the conduit. For example, the conduit may comprise a capillary siphon in order to hold liquid in the liquid holding chamber as the liquid holding chamber fills. Once the liquid holding chamber has been filled with liquid, the device is then slowed or stopped to allow liquid to flow out of the liquid holding chamber and into the outlet conduit under the action of capillary forces.

The liquid holding chamber may be configured such that the detection chamber is disposed radially outwards of a fill level of liquid in the liquid holding chamber. In particular the liquid holding chamber may be configured to hold a volume of liquid large enough such that even when the detection chamber is filled with liquid from the liquid holding chamber, a fill level of liquid in the liquid holding chamber is radially inwards of, or at least at the same radial position as, a radially-innermost aspect of the detection chamber. Such a configuration enables the complete filling of the detection chamber under the action of centrifugal force. In other words, the liquid holding chamber act as communicating vessels and there must be a sufficient column of liquid in the liquid holding chamber such that exerting a centrifugal pressure on this liquid column results in the filling of the detection chamber.

In some embodiments, the liquid holding chamber may be a separation chamber and the method may comprise, after transferring liquid into the liquid holding chamber, rotating the device in order to separate liquid (e.g. a blood sample) in the liquid holding chamber into fractions of differing densities (e.g. platelets, red and white blood cells, plasma).

In a further aspect there is provided a microfluidic liquid handling device configured for rotation about an axis of rotation to drive liquid flow within the device, the device comprising a detection chamber. The detection chamber comprises a liquid inlet, a liquid outlet disposed radially inward of the inlet, for example at a radially innermost aspect of the detection chamber and an outlet conduit connected to the liquid outlet configured to facilitate flow of an aqueous liquid out of the detection chamber and along the conduit by capillary action. As described above, in some embodiments, the detection chamber may comprise a vent port radially inwards of the inlet.

Advantageously, liquid may be transferred into the detection chamber under the action of centrifugal force, thus forcing any gas already present in the detection chamber, in addition to gas present in the liquid in the form of gas bubbles, radially inwards of the liquid. Due to the position of the outlet radially inwards of the inlet, the gas is vented out of the detection chamber via the outlet as the detection chamber fills. The device can then be slowed or stopped to facilitate flow of liquid out of the detection chamber via the outlet under the action of capillary forces.

In some embodiments, the liquid inlet is disposed on a radially outermost aspect of the detection chamber. As a result, the liquid enters the chamber at a radially-outermost aspect of the chamber. The fill level of the liquid then moves radially inwards and the gas present in the detection chamber is forced radially inwards of this liquid as the chamber fills. In other words, the gas is always radially inwards of the liquid, thus reducing the risk of gas becoming trapped in the chamber further.

In some embodiments the device comprises a liquid holding chamber and a conduit connecting the liquid holding chamber to the detection chamber, wherein the conduit extends radially inwards to a crest and radially outwards from the crest, wherein the crest is radially inwards of the liquid outlet of the detection chamber.

In some embodiments, any of the devices described above may be a microfluidic device. For the avoidance of doubt, the term “microfluidic” is referred to herein to mean devices having a fluidic element such as a reservoir or a channel with at least one dimension below 1 mm. The device may be configured to handle volumes of liquid on the scale of nanolitres to microlitres. Examples of liquids include buffer, reagent solutions, whole blood, plasma, serum and urine. Examples of possible reagents include particles, salts, sugars, biologically active elements (antibodies, enzymes etc.) and polymers.

One or more reagents may be disposed anywhere in the device. For example, an anticoagulant such as EDTA, Heparin or Sodium Citrate may be disposed anywhere in the device.

Any of the devices described herein may be configured as a disc, such as a ‘lab-on-a-disc’ device.

In some embodiments, any of the devices described above may be configured for rotation about an axis of rotation to drive liquid flow within the device. Such a device may comprise a drive-engaging feature for engaging a drive mechanism for driving rotation of the device. This feature may define the axis of rotation.

For the avoidance of doubt, it will be understood that any references made herein to flow ‘by capillary’ or ‘under the action of capillary forces’ refers to the flow of liquid along a channel, conduit, or other structure by virtue of surface tension effects, i.e. a greater attraction of the molecules of the liquid to the surface of the structure than to each other.

It will be appreciated that the structures described above may all be part of the same device and, for example, interact as described below. Equally, the various structures described above may be independently embodied on separate devices. Similarly, the methods described above may be used in combination (for example in using one device) or may be used separately, e.g. with separate devices.

### BRIEF DESCRIPTION OF THE FIGURES

Specific embodiments are now described by way of example with reference to the drawings, in which:

FIGS. 1-4 each illustrate an embodiment of a liquid handling device particularly suitable for platelet counting;

FIG. 5 illustrates another aspect of the liquid handling device facilitating accurate object counts;

FIG. 6 illustrates a further embodiment of an aspect of the liquid handling device of FIG. 5;

FIG. 7a illustrates schematically yet another aspect of the liquid handling device facilitating bubble free filling of a detection chamber; and

FIGS. 7b, 7c and 7d illustrate liquid flows within the device shown in FIG. 7a;

FIGS. 7e, 7f and 7g illustrate alternative embodiments of an aspect of the structure shown in FIG. 7a;

FIGS. 8a, 8b and 8c illustrate schematically liquid handling structures of device further aspect of the device, for controlling flow volumes, in a first cross-section;

FIG. 9 illustrates schematically liquid handling structures of the device of FIGS. 8a, 8b and 8c in a second cross-section taken in a direction perpendicular to that of the first cross-section;

FIG. 10 illustrates schematically a system for capturing images of a liquid sample in aspects of the device of FIGS. 8a, 8b, 8 c and 9;

FIG. 11 illustrates schematically a system for capturing images as liquid flows through a device as described herein; and

FIG. 12 illustrates schematically a method of counting platelets.

### DETAILED DESCRIPTION

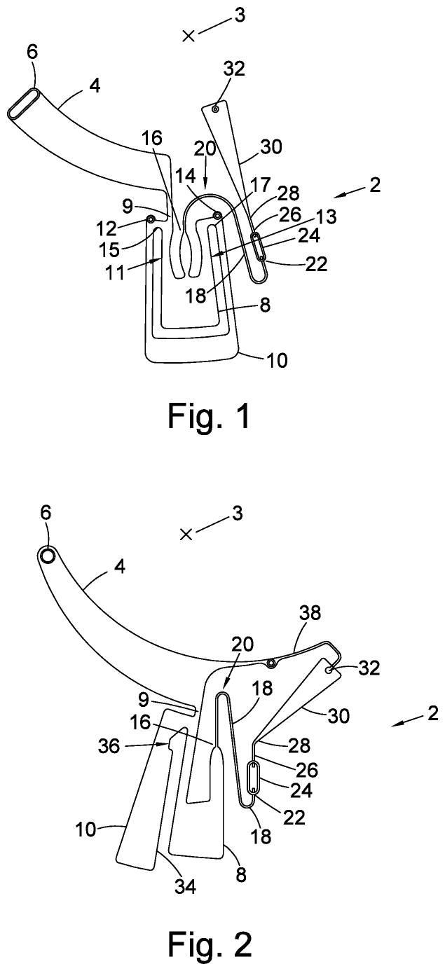

With reference to FIG. 1, a device 2 is configured for rotation about an axis of rotation 3 to drive liquid flow within the device. The device may be a microfluidic device such as a ‘lab on a disk’ device. The device 2 may comprise a feature (not shown) configured to engage with a drive mechanism for rotating the device and this feature may define the axis of rotation about which the device is rotated.

The device 2 comprises an inlet chamber 4 with a liquid inlet 6 via which liquid is transferred into the inlet chamber 4. This may be done by a user with a pipette, for example. Alternatively, the inlet 6 may be connected to an upstream structure of the device (for example another chamber or conduit).

The inlet chamber 4 is connected to a sedimentation chamber 8 via an inlet 9 of the sedimentation chamber 8. The sedimentation chamber 8 is configured to, in use, receive liquid from the inlet chamber 4. The sedimentation chamber 8 has an outlet 16 which is disposed at a radially-innermost aspect of the sedimentation chamber 8. A width of the sedimentation chamber in a circumferential direction increases in a radially inwards direction and then decreases in a radially inwards direction to connect to the outlet 16. In other words, the sedimentation bulges outwards (in a circumferential direction) and then narrows back in again to connect to the outlet 16.

The sedimentation chamber 8 is also in communication with an overflow chamber 10. The sedimentation chamber 8 is separated from the overflow chamber 10 by two walls 11 and 13. Each of the walls 11 and 13 extend from the sedimentation chamber 8 radially inwards to respective crests 15 and 17. Each of these crests are positioned radially inwards of outlet 16 to ensure the outlet 16 is wetted, as is described in detail below.

The outlet 16 is connected to a conduit 18, which is dimensioned so as to facilitate flow of liquid, in particular an aqueous liquid, along the conduit by capillary action. Alternatively or additionally, chamber 30 may contain a liquid absorbing medium, such as a porous medium, for example a textile, filter paper or foam member which acts to draw liquid through the device, along conduit 20. The conduit extends radially inwards from the outlet 16 to a crest 20 and then radially outwards from the crest.

The conduit 18 is connected to an inlet 22 of a detection chamber 24. The inlet is disposed on a radially-outermost aspect of the chamber 24. The detection chamber 24 is configured to facilitate capture of one or more images of the liquid as it flows through detection chamber 24. For example, a surface of the detection chamber may be transparent or translucent.

The detection chamber 24 also comprises a liquid outlet 26 which is disposed at a radially innermost aspect of the detection chamber 24 and which is in turn connected to an outlet conduit 28. The outlet conduit 28 is configured so as to facilitate flow of liquid, in particular an aqueous liquid, along the conduit by capillary action. As mentioned above, alternatively or additionally, the chamber 30 may comprise a liquid absorbing medium to induce capillary flow along conduit 28. The outlet conduit 28 is connected to a waste chamber 30. Waste chamber 30 comprises a vent 32 to facilitate venting of air out of the chamber as the waste chamber 30 fills. The device 2 further comprises two gas vents 12 and 14 to vent the sedimentation chamber 8 and overflow chamber 10. Vents 32, 12 and 14 may be in communication with the atmosphere external to the device 2 or may be connected to an internal air circuit.

Liquid flows in the device 2 will now be described. In use, as a first step, liquid comprising a number of components of differing densities (e.g. a blood sample) is inserted into the inlet 6. For the purposes of clarity, blood will be used as an example in what follows but it will be appreciated that the methods and devices described herein are not limited to use with a blood sample. Any liquid which comprises portions of differing densities may be processed using the methods and devices described herein.

Liquid is transferred into the inlet chamber 4 via liquid inlet 6 and fills the inlet chamber 4. The device is then rotated in order to transfer liquid from the inlet chamber 4 into the sedimentation chamber 8 under the action of centrifugal force. As liquid fills the sedimentation chamber, a fill level of liquid in the sedimentation chamber rises (i.e. moves radially inwards). Eventually, the fill level reaches the level of crests 15 and 17. At this point, some liquid overflows into the overflow chamber 10. This leaves a well-defined volume of liquid in the sedimentation chamber 8. Advantageously, because crests 15 and 17 are disposed radially inwards of the outlet 16, liquid comes into contact with outlet 16 before liquid overflows into the overflow chamber. Provided enough liquid is transferred into the inlet chamber 4, this feature facilitates the consistent contacting of liquid with the outlet 16. As mentioned above, the outlet conduit 18 (which is connected to outlet 16) may be dimensioned so as to facilitate flow of liquid, in particular an aqueous liquid, along the conduit by capillary action. Under the action of centrifugal force, liquid is prevented from being drawn into the conduit 18 under the action of capillary forces (since the capillary forces are balanced by the centrifugal force), but in order to cause liquid to exit the sedimentation chamber subsequently via conduit 18, it is necessary to ensure that liquid comes into contact with the outlet 16.

Rotation is continued in order to radially separate components of the blood in the sedimentation chamber 8. Under the action of centrifugal force, the most dense component of the blood (i.e. the red blood cells) settles in the radially-outermost aspect of the sedimentation chamber 8, with components having lower density settling radially inwards of it. In particular, the plasma is the radially-innermost component of the blood after separation.

Once the liquid has been sedimented, the rotational frequency of the device is reduced (or rotation of the device is stopped completely). Capillary forces acting to draw liquid from the sedimentation chamber into the conduit 18 are no longer balanced by the centrifugal force and liquid (in particular, plasma, is drawn into the conduit 18 by capillary action traverses the crest of the conduit 18. Once liquid has passed the crest 20, the rotational frequency of the device is increased (or rotation is restarted) to drive liquid flow radially outwards, along the conduit 18.

Liquid flows along conduit 18 enters the detection chamber 24 via inlet 22 and fills the detection chamber against the action of centrifugal force. Filling the detection chamber 24 in this way, i.e. using the centrifugal force, has the benefit of removing gas bubbles from the liquid and displacing the gas that was already present in the detection chamber 24 radially inwards, ahead of the liquid, and out via outlet 26. Centrifugally driven flow continues until the sedimentation chamber 8 and the conduit 28 are filled to the same radial position, as they act as communicating vessels.

Once the detection chamber 24 has been filled with liquid and liquid flow ceases, the rotational frequency of the device is reduced (or rotation is stopped). Capillary forces act to draw liquid from the detection chamber 24 into the outlet conduit 28 and subsequently into the waste chamber 30. Liquid thus flows through the detection chamber 24 by capillary action. As liquid flows, the liquid is observed. For example, one or more images of the liquid may be captured as it flows through the detection chamber 24. Alternatively, flow cytometry may be carried out as the liquid flows, for example. The data collected can then be used to determine once or more characteristics of the sample, for example an object count (e.g. a count of platelets present in the plasma).

As liquid continues to flow into the waste chamber 30, gas is displaced along the waste chamber 30 and out of the vent 32. Eventually, the waste chamber 30 is completely filled with liquid and flow into the waste chamber 30 stops because no more liquid is able to flow into the waste chamber 30.

Specific features of the liquid handling features described above will be described below in more detail, discussing various advantages of the specific characteristics and configurations of the structures described above with reference to FIGS. 1 to 4.

With reference to FIG. 2, a further embodiment of the liquid handling device 2 is described. The embodiment of FIG. 2 has a number of features in common with the embodiment described with reference to FIG. 1 and like parts are labelled with like reference signs. In the interest of brevity and to avoid repetition, only the differences between FIG. 2 and FIG. 1 will now be described.
The sedimentation chamber 8 is separated from the overflow chamber 10 by a wall 34 which comprises a projection 36 projecting into the overflow chamber 10. This has the effect of breaking the surface of the liquid between the sedimentation chamber 8 and the overflow chamber 10. Advantageously, the projection is configured to prevent a continuous meniscus between liquid in the overflow chamber 10 and liquid in the sedimentation chamber 8. Such a meniscus could result in liquid being drawn back into the sedimentation chamber 8 from the overflow chamber 10 as liquid flows out of the sedimentation chamber 8, introducing variability in the volume that could be extracted from the sedimentation chamber, as described in greater detail below. The waste chamber 30 is oriented differently to the embodiment of FIG. 1—it is angled with respect to a radial direction in order to reduce the amount of radial space (which may be limited) taken up by the waste chamber 30.
The sedimentation chamber 8 has a different configuration. In FIG. 2, the sedimentation chamber 8 is connected to the overflow chamber 10 at a single point only (as opposed to at two points, as in the structure shown in FIG. 1). Further, a width of the sedimentation chamber (i.e. an extent of the sedimentation chamber in a circumferential direction) decreases steadily in a radially-inwards direction to connect to the outlet 16.
The device 2 comprises an internal air circuit 38, connecting the vent 32 of the detection chamber 30 to the inlet chamber 4. As liquid flows through the device, gas which is displaced by liquid flow is vented out of vent 32 and back into the inlet chamber 4.

It will be understood that, in some embodiments, any, some or all of these differences are applied to FIG. 1, 3 or 4.

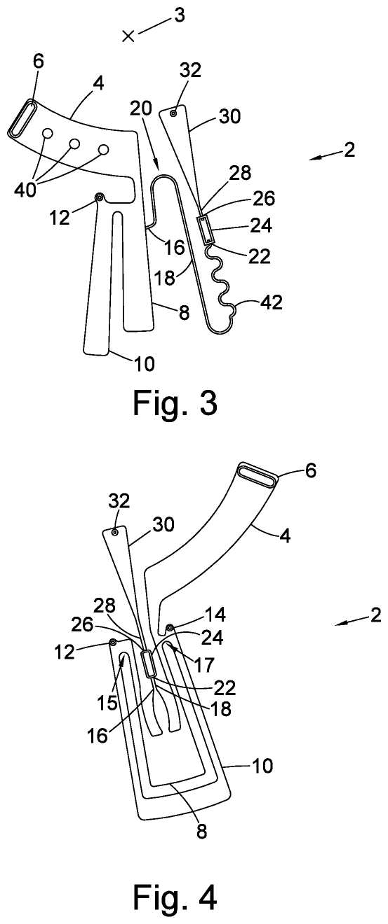

With reference to FIG. 3, a further embodiment of the liquid handling device 2 is described. The embodiment of FIG. 3 has a number of features in common with the embodiment described with reference to FIG. 1 and like parts are labelled with like references. In the interest of brevity, the differences between FIG. 3 and FIG. 1 will now be described.
The inlet chamber 4 comprises a number of support pillars 40 which provide structural support to the chamber 4. The device 2 may be produced by producing two substrates each comprising various hollows which, when the two substrates are adhered together, form the various liquid handling structures (chambers, conduits etc.) described herein. Alternatively, the device 2 may be produced by creating a single substrate defining the liquid handling structures and attaching a film to the substrate to seal the liquid handling structures. In the case where a film is used, structural supports such as pillars 40 may be used to support the film above various chambers and prevent it collapsing into the chamber in the event that pressure is applied to the film.
The conduit 18 comprises a serpentine structure 42. In other words, the conduit 18 comprises a plurality of bends. This has the effect of creating turbulence in the liquid as it flows along the serpentine structure and improves uniformity of the liquid. In particular, it may improve the uniformity of a distribution of objects in the liquid (for example platelets in plasma).
The outlet 16 is not positioned on a radially-innermost aspect of the sedimentation chamber 8. Instead, the outlet 16 is positioned on a side of the sedimentation chamber 8, radially outwards of a radially-innermost aspect of the sedimentation chamber 8. The serpentine structure, which improves intermingling of the liquid as it flows along conduit 12, is designed to make up for any inhomogeneity in the distribution of objects in the liquid (e.g. platelets in plasma) which occurs by virtue of extracting liquid from the side of the sedimentation chamber 8, as opposed to from a radially-innermost aspect, as will be described in more detail below.
In this embodiment, the detection chamber 24 may be filled by capillary flow, rather than under the action of centrifugal force. In some variants, by timing the filling of the conduit 18 or introducing a valve, such as a surface tension valve, in the conduit 18, the detection chamber may be filled by centrifugation as described above once the conduit 18 has primed by capillary force.

It will be understood that, in some embodiments, any, some or all of these differences are applied to FIG. 1, 2 or 4.

With reference to FIG. 4, a further embodiment of the liquid handling device 2 is described. The structure shown in FIG. 4 is equivalent to that shown in FIG. 1 with a number of exceptions; the conduit 18 does not comprise a crest 20 but instead extends directly radially inwards to connect to the inlet 22 of the detection chamber 24. Further, the crests 15 and 17 are disposed radially inwards of a radially-innermost aspect of the detection chamber 24. This has the effect that, in use, when liquid is transferred into the sedimentation chamber 8 from the inlet chamber 4, the detection chamber 24 is also filled under the action of the centrifugal force before liquid overflows into the overflow chamber 10. As above, the device is then rotated in order to sediment the liquid. Since the detection chamber already contains liquid, liquid in the detection chamber 24 is also separated into its constituent parts and the denser fractions move radially outwards, into the sedimentation chamber under the action of centrifugal force. Once rotation is stopped (or the rotational frequency of the device is reduced) liquid is drawn into the conduit 18 by capillary action and flow of liquid through the detection chamber 24 ensues, as described above.

In embodiments in which liquid is transferred into the detection chamber before the device is rotated in order to sediment phases of the liquid (e.g. as described with reference to FIG. 4), it may be advantageous to configure the detection chamber to have a portion in which the highest density fraction of the liquid (red blood cells in the case that the liquid is blood) is captured during sedimentation. In particular, if the detection chamber is angled with respect to a radial direction (i.e. the detection chamber is not aligned in a radial direction), a wall of the detection chamber which faces radially outwards may extend radially outwards and then radially inwards again to form a pocket in which the highest density fraction is captured. During sedimentation, the highest density fraction collects in the pocket under the action of centrifugal force. During subsequent flow of the liquid through the detection chamber under the action of capillary forces, the highest density fraction is held out of the way of the flow of liquid (in the pocket) and thus does not hinder flow. In some embodiments the shape of the detection chamber 24 may be configured to facilitate return of any heavier phases such as red blood cells into the sedimentation chamber 8, for example by configuring a radially outer aspect to have a smooth transition to the conduit 18 in the region of the inlet 22.

It will be understood that, in some embodiments, any, some or all of these differences are applied to FIG. 1, 2 or 3.

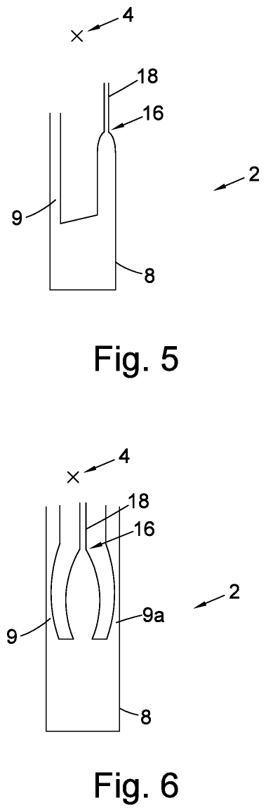

A portion of the structures shown in FIGS. 1-4 is now described with reference to FIGS. 5 and 6. It will be appreciated that the features of the structure described below may be used independently of the features shown in FIGS. 1-4. In other words, some aspects of the structures shown in FIGS. 1-4 may be omitted. In particular, a process of extracting liquid from the top of the chamber was described with reference to FIGS. 1-4. This concept and its advantages will now be described in further detail with reference to FIGS. 5 and 6. Like reference numerals will be used for like features.

With reference to FIG. 5, a liquid handling device 2 is configured for rotation about an axis of rotation 4. The device 2 comprises a chamber 8 with a liquid inlet 9 and a liquid outlet 16. The liquid inlet is disposed radially inwards of, or at the same radial position as, the liquid outlet. The liquid outlet 16 is connected to an outlet conduit 18 which is dimensioned so as to facilitate flow along the conduit 18 by capillary action. In particular, the outlet conduit 18 is dimensioned so as to facilitate flow of an aqueous liquid along the conduit 18 by capillary action. For example, the conduit 18 may have at least one dimension which is less than 200 μm. The dimensions of the conduit 18 will depend on the materials used. Alternatively or additionally, the device may comprise a liquid absorbing medium which acts to draw liquid through the device. The outlet conduit extends from the outlet radially inwards such that as liquid flows out of the chamber via the outlet, the liquid flows in a radially-inwards direction.

A width of the chamber 8 decreases in a radially-inwards direction to connect to the outlet 16. In other words, a width of the chamber 8 at a first radial position is greater than a width of the chamber 8 at a second radial position, radially inwards of the first radial position. The width of the chamber 8 decreases steadily between the first and second radial positions, as shown in FIG. 5. This shape facilitates that liquid from the full width of the chamber 8 is drawn into the conduit 18 (and not just liquid from the centre of the chamber 8, for example).

In some embodiments, the chamber 8 may be connected to an overflow chamber configured such that liquid fills the chamber 8 up to a certain radial position before overflowing into the overflow chamber. In such embodiments, is important that the outlet 16 is radially outwards of this radial position to ensure that the outlet conduit 16 is contacted by liquid before liquid starts overflowing from the chamber 8 into the overflow chamber 10, for reasons that will be described below with reference to the liquid flows in the device.

In use, liquid is transferred into the chamber 8 via the inlet 9 from an upstream liquid handling structure (not shown) under the action of centrifugal force, by rotating the device 2 about the axis 4. In some embodiments, liquid may be transferred into the chamber by other means.

Liquid is transferred into the chamber 8 at least to an extent that the outlet 16 is contacted by liquid. The chamber 8 may be filled with liquid completely to ensure that this occurs, for example. The device 2 is then rotated in order to sediment the liquid. For example, the liquid may be a blood sample and rotating the device may cause the blood sample to sediment into its various components. Whilst the device is rotated, liquid is prevented, by the resulting centrifugal force, from flowing along the outlet conduit 18 under the action of capillary forces.

Once the sample has separated into its constituent parts, the rotational frequency of the device 2 is then decreased or rotation is stopped completely. The centrifugal force acting on the liquid is thus reduced (or removed entirely) such that capillary forces acting to draw liquid into the outlet conduit 18 are no longer balanced by the centrifugal force. Liquid is therefore drawn into the conduit 18. Since the sample has been separated, the least dense component of the sample (plasma, in the case of a blood sample) is disposed at the radially-innermost aspect of the chamber 8 and it is this component that is drawn into the outlet conduit 18 first. Liquid flows along the conduit 18 radially inwards and optionally into a downstream liquid handling structure in communication with the outlet conduit 18, for example a detection chamber and/or a waste chamber.

As explained above, extracting liquid in a radially-inwards direction (as opposed to from the side of the sedimentation chamber) is advantageous. After sedimentation, there is a density gradient in the liquid present in the sedimentation chamber. By extracting liquid in a radially-inwards direction, the density of the liquid (i.e. the number density of objects in the liquid) which flows through the conduit 12 increases over time but is substantially uniform across the conduit 12. In the event that the liquid is imaged during flow further on downstream, the density of the liquid being imaged thus increases over time too and averages out over time.

Conversely, if liquid were extracted from the side of the sedimentation chamber, the density of the liquid (i.e. the number density of objects in the liquid) would vary across the width of the conduit 18. As mentioned above, images of the liquid during capillary flow may be captured, either in conduit 18 or in a detection chamber (e.g. detection chamber 24 in FIGS. 1-4) in communication with conduit 18. Usually, the field of view of the camera used is entirely within the width of the conduit (i.e. the walls of the conduit are not in the field of view). As such, only part of the width of the conduit 18 is imaged. In the event that the number of objects in the liquid is not substantially uniform across the width of the chamber (as is the case with extracting liquid from the side of the sedimentation chamber), the images are not truly representative of the number of objects in the sample. For example, there may be a concentration of objects along one wall of the conduit which is not captured in the images. This affects a count of the objects as this bias is not averaged out over time (as is the case with extracting liquid in a radially-inwards direction).

With reference to FIG. 6, a further embodiment of the liquid handling device is shown. Like parts are labelled with like numerals, as for the embodiment of FIG. 5. The chamber 8 comprises a first liquid inlet 9, a second liquid inlet 9a and a liquid outlet 16. As for the embodiment of FIG. 5, the outlet conduit 18 extends radially inwards from the outlet of the chamber 8 and is dimensioned so as to facilitate flow along the conduit 18 by capillary action. A width of the chamber 8 increases and then decreases again in a radially-inwards direction to connect to the outlet 16. In this way, a portion of the chamber 8 bulges outwards (in a circumferential direction) and then narrows again to connect to the outlet 16.

It will be appreciated that in order to extract liquid from the chamber 8 by capillary action via the outlet 16, the liquid 16 must be contacted with liquid (i.e. wetted). In order to achieve this, the chamber 8 must be filled with liquid at least up to the radial position of the outlet 16.

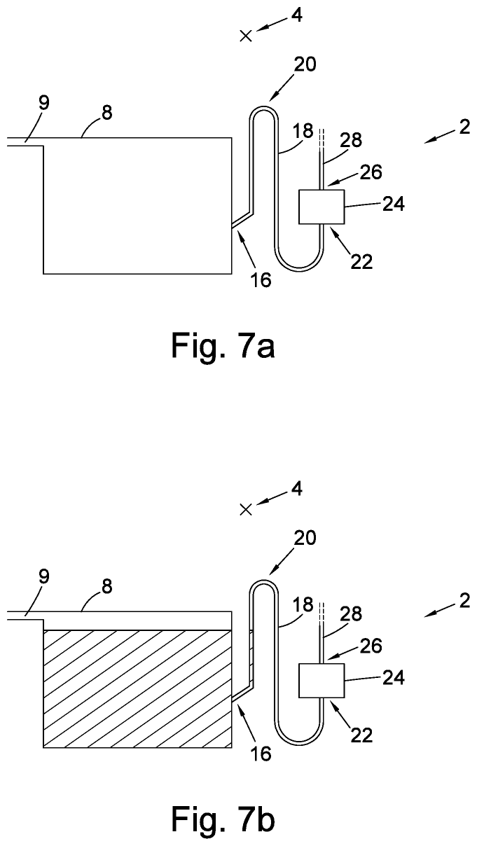

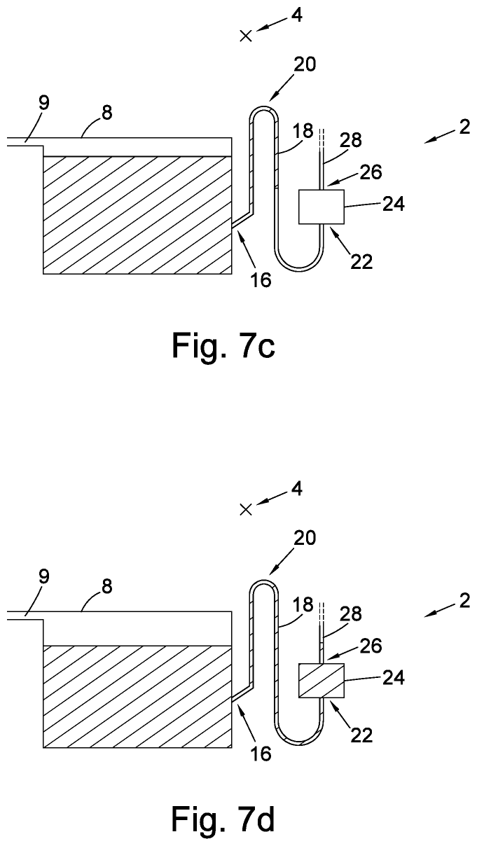

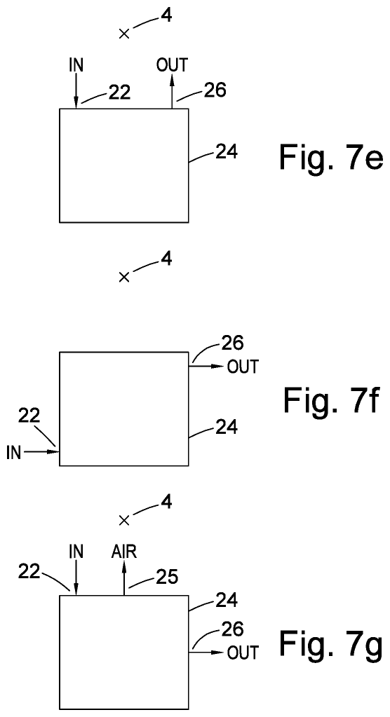

A portion of the structures shown in FIGS. 1-4 is now described with reference to FIGS. 7a, 7b, 7c and 7d. It will be appreciated that the features of the structure described below may be used independently of the features shown in FIGS. 1-4. In other words, some aspects of the structures shown in FIGS. 1-4 may be omitted. In particular, a detection chamber 24 was described with reference to FIGS. 1-4. The specific configuration and advantages of such a detection chamber are now described in more detail with reference to FIGS. 7a, 7b, 7c and 7d. Like reference numerals are used where features which are also shown in FIGS. 1-4 are described.

With reference to FIG. 7a, a liquid handling device 2 is configured for rotation about an axis of rotation 4 to drive liquid flow within the device. The device 2 comprises a chamber 8 with a liquid inlet 9 and a liquid outlet 16. The outlet 16 is connected to a conduit 18 which extends radially inwards to a crest 20 and then radially outwards from the crest 20.

The device 2 further comprises a detection chamber 24 with a liquid inlet 22 which is connected to the conduit 18 for receiving liquid from the chamber 8. The liquid inlet 22 is disposed on a radially outermost aspect of the detection chamber 24. The detection chamber 24 also comprises a liquid outlet 26, which is disposed in a radially innermost aspect of the detection chamber 24. The outlet 26 is connected to a further conduit 28.

Liquid flows within the device are now described with reference to FIGS. 7b, 7c and 7d.

With reference to FIG. 7b, in use, the device 2 is rotated to transfer liquid into chamber 8 from an upstream liquid handling structure (not shown) via inlet 9. As the liquid holding chamber 8 fills with liquid, some liquid enters the conduit 18 and fills the conduit 18 up to the level of liquid in the chamber 8. As the crest 20 of the conduit 18 is disposed radially inwards of the radially-innermost aspect of the chamber 8, liquid does not traverse the crest 20 but is instead held upstream of the crest 20 under the action of centrifugal force.

Once the chamber 8 is filled with liquid, the rotational frequency of the device 2 is reduced (or rotation is stopped). Capillary forces acting to draw liquid along conduit 18 are now no longer balanced by the centrifugal force and so liquid flows along the conduit 18 and traverses the crest 20, as shown in FIG. 7c. Once liquid has passed the crest 20 and begins to flow radially outwards again, along the conduit 20, the rotational frequency is increased (or rotation is restarted) to drive liquid flow along the conduit 18 and into the detection chamber 24 under the action of centrifugal force.

As described above, liquid is transferred into the detection chamber 24 by rotation. Accordingly, liquid enters the detection chamber 24 via the inlet 22, which is disposed on a radially-outermost aspect of the chamber 24, and fills the chamber 24 in a radially inwards direction, against the action of centrifugal force (which acts in a radially outwards direction). The liquid is more dense than the air which is present in the detection chamber 24 and the air therefore remains radially inwards of the liquid and is forced out of the chamber via the outlet 26 as the detection chamber 24 fills with liquid. Further, bubbles present in the liquid are forced out of the liquid, radially inwards of it, under the action of centrifugal force.

In order to fill completely the detection chamber 24 by rotating the device 2, the fill level of liquid in the chamber 8 must be radially inwards of the radially innermost aspect of the detection chamber 24. Accordingly, the chamber 8 should be dimensioned and the volume of liquid transferred into the liquid holding chamber 8 should be selected in order to facilitate this.

The embodiment shown in FIG. 7a and the above-described method facilitates the complete filling of the detection chamber 24 with liquid and the removal of gas bubbles in the liquid and the gas present in the chamber 24 before it is filled.

Once the detection chamber 24 has been filled with liquid and any gas removed from the chamber 24, as shown in FIG. 7d, rotation of the device is stopped. Capillary forces draw liquid into the conduit 28 from the chamber 24. Liquid continues to flow out of the chamber 24 by capillary and in turn, liquid is drawn into the chamber 24 from the conduit 18 via inlet 22. Capillary flow through the detection chamber 24 ensues. A liquid absorbing medium disposed in the device may act to draw liquid through the detection chamber 24 by capillary action.

One or more images of the liquid as it flows through the detection chamber 16 may then be captured for analysis. Alternatively, flow cytometry may be carried out on the liquid as it flows through the detection chamber 24.

Variations of the embodiment shown in FIG. 7a are of course possible. For example, the crest 20 of the conduit 18 (i.e. the capillary siphon) may be replaced by another valve which prevents liquid flow along conduit 18 and into the detection chamber 24 until the desired time.

Further, with reference to FIGS. 7e, 7f and 7g, various configurations of the inlet 22 and the outlet 26 are possible.

With reference to FIG. 7e, the inlet 22 and the outlet 22 may be disposed on a radially-innermost aspect of the chamber 24.

Equally, as shown in FIG. 7f, the inlet 22 may be disposed on a first side of the chamber 24 and the outlet 26 may be disposed on a second side of the chamber 24, opposed to the first side. For example, the inlet 22 may be disposed radially inwards of the outlet 26.

With reference to FIG. 7g, the chamber 24 may comprise an air outlet 25. The inlet 22 may be disposed on a radially-innermost aspect of the chamber 24 and the outlet 26 may be disposed radially outwards of the inlet 22 and the air vent 25.

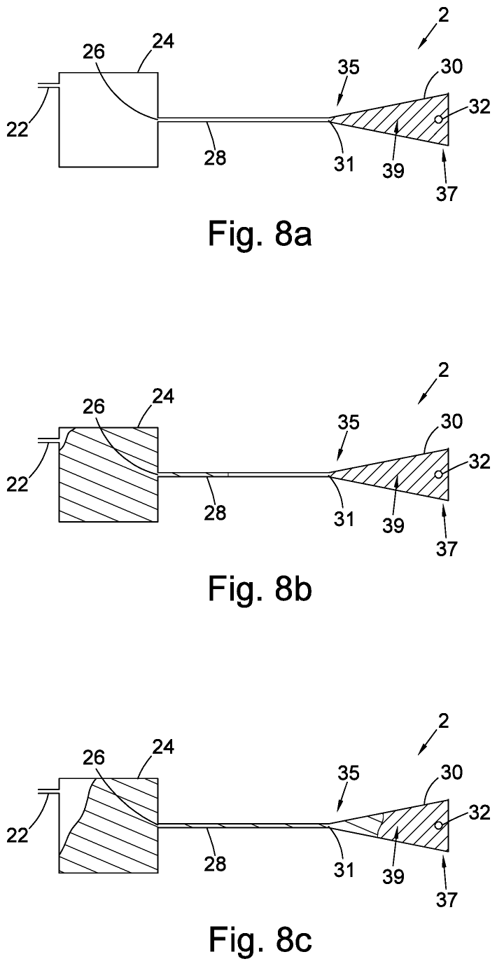

A portion of the structures shown in FIGS. 1-4 is now described with reference to FIGS. 8a, 8b, 8c, 9, 10 and 11. It will be appreciated that the features of the structure described below may be used independently of the features shown in FIGS. 1-4. In other words, some aspects of the structures shown in FIGS. 1-4 may be omitted. In particular, a waste chamber 30 configured to meter flow volumes was described above with reference to FIGS. 1-4. Specific configurations and advantages of such a waste chamber will now be described with reference to FIGS. 8a, 8b, 8c, 9, 10 and 11. Like reference numerals will be used for aspects of the various structures which correspond to the structures shown in FIGS. 1-4.

FIG. 8a shows a device 2 comprising a chamber 24. The chamber 24 may be a detection chamber, for example (in line with the embodiments described with reference to FIGS. 1-4) but may equally be a liquid holding chamber, which is not configured as a detection chamber, for example. The chamber 24 comprises a liquid inlet 22 for receiving liquid. The liquid inlet 22 may be connected to a liquid handling structure upstream of the chamber 24 (not shown), or the inlet 22 may be an external liquid inlet for receiving liquid from outside of the device 2.

The chamber 24 also comprises an outlet 26, which is connected to a conduit 28. The conduit 28 is dimensioned to facilitate flow of a liquid, for example an aqueous liquid, through the conduit 28 by capillary action. The conduit 28 may have at least one dimension which is less than 200 μm for example. The dimensions of the conduit 18 will depend on the materials used. Alternatively or additionally, chamber 30 may contain a liquid absorbing medium, for example a porous material, which acts to draw liquid through the conduit 28 once it has been wetted.

The device 2 further comprises a downstream liquid handling structure, specifically a waste chamber 30. The waste chamber 30 comprises an inlet 31, which is connected to the conduit 28, and a vent port 32 for allowing gas to escape out of the waste chamber 30. The vent port 32 may be connected to an internal air circuit or to a further structure of the device 2 which is vented. Alternatively, the vent port 32 may be in communication with atmospheric pressure. The vent port 32 may be disposed adjacent to a capillary valve, to prevent liquid leaving the chamber 30 via the vent port 32.

A width of the waste chamber 30 at a first end 35 of the chamber is smaller than a width of the downstream chamber at a second end 37 of the chamber 30. The width of the chamber 30 increases steadily between the first end 35 and the second end 37. A bottom surface of the waste chamber 30 is lined with a hydrophilic film 39, as is shown by the hatching in FIG. 1.

The waste chamber 30 has a volume which is smaller than a volume of liquid which is supplied by the chamber 24. In particular, the chamber 24 is configured to hold a first volume of liquid and the waste chamber 30 is configured to hold a second volume of liquid, smaller than the first volume. This relation between the two volumes may be achieved by a metering step in chamber 24, for example, or by a metering step upstream of chamber 24.

Liquid flow through the device shown in FIG. 8a will now be described with reference to FIGS. 8b and 8c. During use, liquid is transferred into the chamber 24, either from outside the device 2 (as described above) or from a liquid handling structure internal to the device, which is upstream of the chamber 24. This may be done under the action of centrifugal force, by rotating the device 2, for example, or by any other means, such as under the action of capillary forces.

When liquid comes into contact with the outlet 26, liquid is drawn into the conduit 28 by capillary forces. Liquid flows along conduit 28 under the action of capillary forces, as shown in FIG. 8b. As liquid flows along the conduit 28, gas present in the conduit 28 is displaced along the conduit and into the waste chamber 30. Gas is then vented out of the waste chamber 30 via the vent port 32. The fact that the width of the chamber 30 increases steadily between the first end 35 and the second end 37 facilitates smooth filling of the waste chamber 30.

As shown in FIG. 8c, liquid subsequently flows from the conduit 28 into the waste chamber 30 and comes into contact with the hydrophilic film 39. Liquid is drawn further into the chamber 30 by the hydrophilic film 39 and gas which is displaced by the flow of liquid into the waste chamber 30 is vented out of the chamber via vent port 32. Liquid continues to flow into the chamber 30 until the waste chamber 30 is completely filled with liquid. At this point, liquid flow stops as no more liquid can enter the waste chamber 30.

Since the waste chamber 30 is completely filled with liquid, the volume of liquid present in the chamber 30 is equal to the volume of the chamber itself and so is a known quantity. Knowledge of this quantity can be useful if the liquid is imaged on its way from the chamber 24 to the waste chamber 30, for example in conduit 28, or as it flows through the chamber 24 itself, because the volume of liquid in the chamber 30 is the volume of liquid which has been imaged. Knowing the volume of liquid that has been imaged is useful in determining characteristics of the liquid. For example, if the images are used to count objects (for example cells or platelets) in the liquid, the volume of liquid can be used to obtain an object count, for example a blood cell count (e.g. a cell count per volume of blood).

In some embodiments, the conduit 28 may be configured to allow passage of light into the and out of the conduit 28. For example, an upper surface of the device 2 in the region of the conduit 28 may be transparent or translucent. This may facilitate the capture of images as liquid flows through conduit 28, or flow cytometry on the liquid as it flows through the conduit 28.

In some embodiments, the conduit 28 may comprise a detection chamber configured to facilitate flow of liquid through the detection chamber under the action of capillary forces. The detection chamber may be configured to allow passage of light into the and out of the detection chamber. For example, an upper surface of the device 2 in the region of the conduit 28 may be transparent or translucent. This may facilitate the capture of images as liquid flows through the detection chamber, or flow cytometry on the liquid as it flows through the detection chamber. Alternatively, the chamber 24 may be configured as a detection chamber and liquid may be caused to flow through chamber 24 under the action of capillary forces by any of the means described above and the liquid may be imaged or otherwise observed as it flows through the chamber 24.

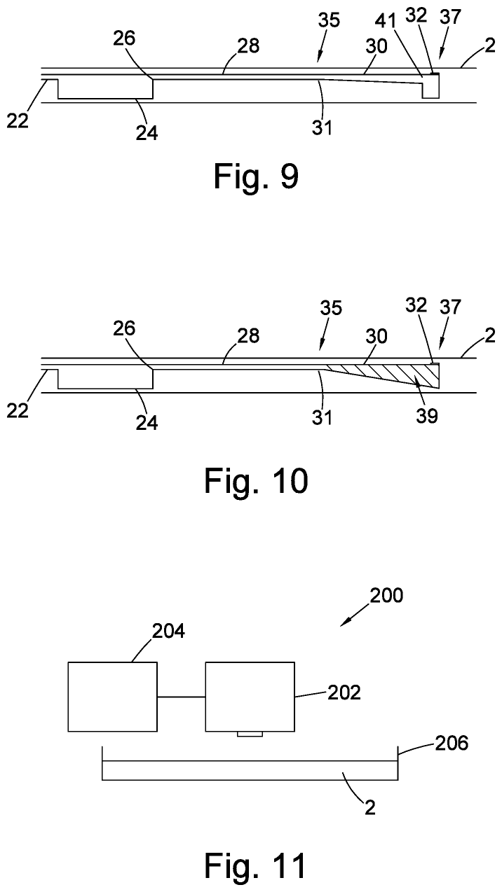

In some embodiments, instead of being completely filled with liquid, the waste chamber 30 comprises a flow-halting feature configured to halt the flow of liquid into the chamber 30 when liquid comes into contact with the feature, whilst still allowing gas to escape out of the chamber 30. Examples of flow-halting features include a capillary valve or any other gas-permeable valve. For example, a patch of hydrophobic material or a step-change in the cross-sectional area of the waste chamber 30 could be used to halt liquid flow. Configuring the chamber 30 in this way (i.e. using a flow-halting feature) has the same effect as completely filling the chamber in terms of determining the volume that has passed through the conduit 28, as will now be explained with reference to FIG. 9. In such embodiments, the chamber 30 is not completely filled. Instead, the chamber merely fills up to the flow-halting feature.

With reference to FIG. 9, the waste chamber 30 comprises a capillary valve 41 (i.e. a step change in the depth of the chamber 30). In use, liquid flows into the chamber 30 by capillary action, as for the other embodiments, and as liquid flows into the chamber 30, gas is displaced along the chamber and out through the vent 32. When liquid reaches the step-change in depth, capillary flow halts and liquid does not move any further into the waste chamber 30. The volume of liquid which can be held in the waste chamber 30 (i.e. the volume of the chamber up to the step-change in depth) is known and so the volume of liquid which has flowed through the conduit 28 can again be deduced and this quantity may be used in analysing the liquid. It will be appreciated that a step-change in width of the chamber 30 (in addition to or instead of a step-change in the depth) may be used instead. Equally, any other suitable valve which halts capillary flow but allows passage of gas may be used.

It will be understood that, in some embodiments, the waste chamber 30 may equally have other shapes. The downstream chamber may be an elongated chamber with constant width and depth or may equally be any other shape which facilitates flow of liquid into the downstream chamber by capillary action and which reduces or eliminates bubble formation, such that the downstream chamber may be filled completely (or at least substantially completely) with liquid or is filled up until a flow-halting feature. For example, the waste chamber 30 may instead be a long, narrow channel or may comprise a plurality of interconnected chambers or structures.

The shape of the waste chamber 30 shown in FIG. 8a, whereby a width of the chamber 30 increases steadily from a first end 35 to the other end 37, is advantageous in that it facilitates controlled filling of the waste chamber 30, thereby reducing the risk of bubble formation, and in that it is also compact. The present structures may be implemented on a centrifugal microfluidic disc, for example. Radial space on such discs is limited and the shape of chamber 30 shown in FIG. 8a may thus be advantageous when implemented on such a disc as the shape takes up less radial space than a long, thin chamber of constant width along its length might. Step-changes in the dimensions of the waste chamber 30 are avoided in order to facilitate flow of liquid into the waste chamber 30 under the action of capillary forces.

The above advantages may also be achieved with different configurations of the waste chamber 30. With reference to FIG. 10, a device 2 is shown in cross-section from the side. Like parts of the device 2 are labelled as for FIG. 8a. In the configuration shown in FIG. 10, a depth of the waste chamber 30 at the first end 35 of the downstream chamber is less than a depth of the downstream chamber at a second end 37. The depth of the downstream chamber increases steadily between the first end 35 and the second end 37 and at least the side walls of the chamber 30 are lined with a hydrophilic film 39.

In some embodiments, both the width and the depth of the waste chamber 30 may increase between the first 35 and second 37 ends of the chamber 30. In other embodiments, only the width of the waste chamber 30 may vary, with the depth of the chamber being constant (or substantially constant) between the first and second ends 35 and 37. In other embodiments, only the depth of the waste chamber 30 may vary, with the width of the chamber being constant (or substantially constant) between the first and second ends 35 and 37.

With reference to FIG. 11, in some embodiments there is provided a system 200 for capturing images of a liquid in a device 2 as described above. This may be used with a device embodying any (i.e. one or more) of the above-described structures, e.g. one or more of the structures described with reference to any of the figures. The system 200 comprises an image capture device 202 which is coupled to and controlled by a processor 204. The system further comprises means 206 for positioning the device 2 relative to the image capture device 202 and holding it in place. The means 206 may be a tray such as that found in a DVD system, for example.

In use, the processor 204 causes the image capture device 202 to capture one or more images of a liquid as it flows through the device 2, in particular as the liquid flows through the conduits 18, 28 or a detection chamber such as chamber 24.

The above-described structures may be used in counting platelets in a blood sample, as will now be explained with reference to FIG. 2. It will be appreciated that a platelet count may be obtained using any of the structures shown in FIGS. 1-4 and FIG. 2 is merely used as an example.

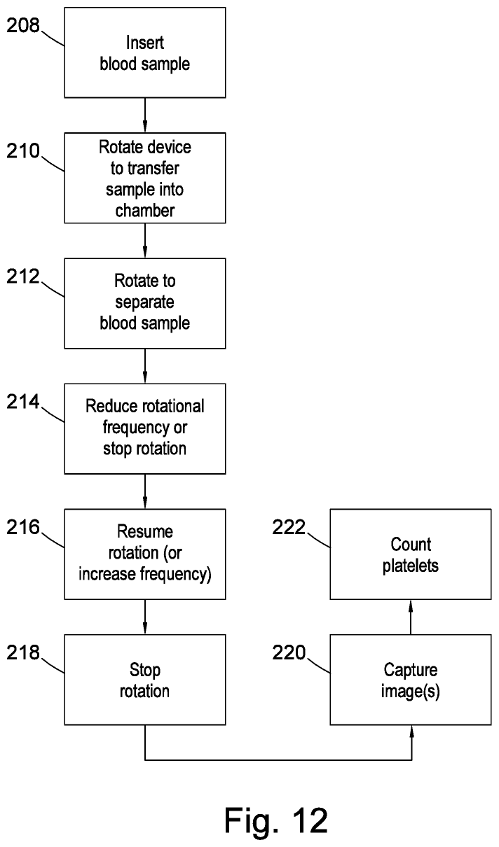

With reference to FIG. 12, at step 208, a blood sample is inserted into the inlet 6 and the sample fills the inlet chamber 4. The device is then rotated, at step 210, in order to transfer the blood sample into the sedimentation chamber 8.

At step 212, rotation is continued in order to separate the blood sample in the sedimentation chamber 8 into its various components. The most dense element (the red blood cells) settle in the radially-outermost aspect of the sedimentation chamber 8 and less dense constituents settle radially inwards of the red blood cells. The plasma, which contains platelets, settles radially inwards of all the other components. Gas bubbles in the liquid are also removed from the liquid under the action of the centrifugal force and are forced radially inwards of the liquid.

An optimised rotation protocol may be used in order to obtain a good distribution of platelets in the plasma (whilst removing red blood cells from the plasma) such that the platelets may be counted more efficiently.

At step 214, the rotational frequency of the device is then reduced (or rotation of the device is stopped completely). Capillary forces act to draw plasma from the sedimentation chamber 8 into the conduit 18 and liquid traverses the crest 20. Rotation is then resumed at step 216 (or the rotational frequency of the device is increased) to drive liquid flow along the conduit 18 and into the detection chamber 24. At step 218, rotation is then stopped and the plasma flows through the detection chamber 24 by capillary action and at step 220, one or more images of the plasma (in particular the platelets in the plasma) are captured as it does so.

As liquid flows into the waste chamber 30, gas is displaced out of the vent 32. Eventually, the waste chamber 30 is completely filled with liquid and flow into the waste chamber 30 stops.

At step 222, platelets in the captured images are then counted. A number of methods for doing so are known, for example template matching but different segmentation methods could also be used. Further, as the waste chamber has been completely filled with liquid, the volume of liquid which has passed through the detection chamber (i.e. the volume of plasma that has been imaged) is known. Thus, the number of platelets per volume of plasma can also be determined.

It will be appreciated that other methods (other than capturing images of the plasma) may be used to count platelets. These include flow cytometry, fluorescence imaging and measuring the impedance of the sample during flow.

A system such as that shown in FIG. 11 and described above may be used to implement the above-described methods.

The above description of embodiments is made by way of example only and various modifications, alterations and juxtapositions of the described features will occur to the person skilled in the art. It will therefore be apparent that the above description is made for the purpose of illustration of embodiments of the invention and not limitation of the invention, which is defined in the appended claims.

1-21. (canceled)

22. A method of handling liquid in a microfluidic device configured for rotation about an axis of rotation to drive liquid flow within the device comprising a chamber with a liquid inlet and a liquid outlet, wherein the liquid outlet is connected to an outlet conduit which is configured to facilitate flow of an aqueous liquid out of the chamber into the conduit by capillary action, wherein the outlet conduit extends from the outlet radially inwards, the method comprising:
transferring a liquid sample having a plurality of components of differing densities into the chamber;
rotating the device about an axis of rotation to separate the liquid sample into the plurality of components;
decreasing the rotational frequency of the device or stopping rotation of the device to cause a specific portion of the liquid containing components of interest to flow out of the chamber via the liquid outlet under the action of capillary forces.

23. A method as claimed in claim 22, wherein the outlet conduit is connected to a detection chamber, which is configured to allow light to pass into and out of the detection chamber, the method comprising:
observing the liquid sample as it flows through the detection chamber by capillary action.

24. A method as claimed in claim 22, wherein the liquid is a blood sample.

25. A method as claimed in claim 23, wherein observing the liquid comprises:
capturing one or more images of the liquid and/or determining one or more characteristics of the liquid.

26-31. (canceled)

32. A method as claimed in claim 23, wherein the separated components may be observed independently according to their density or sedimentation rate.

33. A method as claimed in claim 23, wherein the volume that flows through the detection chamber may be determined based on a downstream flow-halting feature which is configured to halt the flow of the liquid.

34. A method as claimed in claim 33, wherein the flow-halting feature comprises a step change in the cross-sectional area of the downstream liquid handling structure.

35. A method as claimed in claim 33, wherein the flow-halting feature comprises a wall of the downstream liquid handling structure, such that the downstream liquid handling structure is configured to be filled entirely with liquid.

36. A method as claimed in claim 33, wherein the flow-halting feature comprises a piece of hydrophobic material.
